(19) United States
(12) Patent Application Publication
(10) Pub. No.: US 2014/0009092 A1
(43) Pub. Date: Jan. 9, 2014

(54) BATTERY SYSTEM, EQUALIZING APPARATUS, EQUALIZING SYSTEM, ELECTRIC-POWERED VEHICLE, ELECTRIC-POWERED MOVABLE EQUIPMENT, POWER STORAGE DEVICE, AND POWER SOURCE APPARATUS

(71) Applicants: Rui Ma, Hyogo (JP); Tomonori Kunimitsu, Hyogo (JP); Kimihiko Furukawa, Hyogo (JP)

(72) Inventors: Rui Ma, Hyogo (JP); Tomonori Kunimitsu, Hyogo (JP); Kimihiko Furukawa, Hyogo (JP)

(21) Appl. No.: 14/006,439

(22) PCT Filed: Jan. 26, 2012
(86) PCT No.: PCT/JP2012/000494

§ 371 Date: Sep. 20, 2013

(30) Foreign Application Priority Data
Mar. 23, 2011 (JP) 2011-064594

(51) Int. Cl. H02J 7/00; B60L 11/18; H02J 7/02

(52) U.S. Cl. CPC H02J 7/0014; H02J 7/025; B60L 11/1809
USPC 318/139; 320/107; 320/108

(57) ABSTRACT

An equalizing apparatus that includes discharging circuitry and charging circuitry. The discharging circuitry includes a plurality of discharging sections corresponding to the plurality of battery cells in the plurality of battery cell groups. The charging circuitry includes a first coil, a switching device, a plurality of second coils, a plurality of switching devices, and a plurality of diodes. Each of the plurality of second coils, switching devices, and diodes corresponds to a battery cell group. The first coil and second coil form a transformer.

### BACKGROUND OF THE INVENTION

1. Field of the Invention

The present invention relates to a battery system, equalizing apparatus, equalizing system, electric-powered vehicle, electric-powered movable equipment, power storage device, and power source apparatus.

2. Description of the Related Art

A battery system, which includes a plurality of battery cells capable of being charged and discharged, is used as the source of driving power in movable equipment such as an electric automobile (electric car, electric vehicle, EV) and in power storage device applications. The plurality of battery cells are, for example, connected in series.

There is cell-to-cell variation in the charging and discharging characteristics of the plurality of battery cells. Consequently, during battery system operation, cell-to-cell terminal voltage variation develops in the plurality of battery cells. To optimally utilize the inherent capacity of each battery cell, it is necessary to equalize the terminal voltages of the plurality of battery cells.

For example, in the charging apparatus cited in Japanese Patent No. 3279071, a series-connected resistor and transistor is connected between the terminals of each battery cell. In this system, a battery cell with a terminal voltage higher than that of the other battery cells can be selectively discharged through its associated resistor. Accordingly, the terminal voltages of the plurality of battery cells can be equalized.

However, in the charging apparatus described above, when cell-to-cell terminal voltage variation becomes large, the time required to equalize the terminal voltages becomes significant. In addition, this method of terminal voltage equalization is limited to battery cell discharging only.

It is an object of the present invention to provide a battery system, equalizing apparatus, equalizing system, electric-powered vehicle, electric-powered movable equipment, power storage device, and power source apparatus that can efficiently equalize the state of charge for a plurality of battery cells.

### SUMMARY OF THE INVENTION

A battery system for one aspect of the present invention is provided with a plurality of battery cell groups with each group including a plurality of series-connected battery cells, and an equalizing apparatus to equalize the state of charge of the plurality of battery cell groups. The equalizing apparatus includes a plurality of discharging sections established in one-to-one correspondence with each of the plurality of battery cells in the plurality of battery cell groups, and charging circuitry having a plurality of charging sections established in one-to-one correspondence with each of the plurality of battery cell groups. Each discharging section is connected across the terminals of the corresponding battery cell, and each charging section is connected between the highest and lowest potential battery cell terminals of the corresponding battery cell group. Here, a battery cell terminal designates a battery cell positive electrode terminal or a battery cell negative electrode terminal. Further, the state of charge of a battery cell group can be the state of charge of the entire group of battery cells or the state of charge of each battery cell included in the battery cell group.

In this battery system, one or a plurality of discharging sections are provided corresponding to each of the plurality of battery cells, and one or a plurality of charging sections are provided corresponding to each of the plurality of battery cell groups. Each of the plurality of discharging sections is connected across the terminals of the corresponding battery cell. Each of the plurality of charging sections in the charging circuitry is connected between the highest potential battery cell terminal and the lowest potential battery cell terminal in the corresponding battery cell group.

A battery cell among the plurality of battery cells in each battery cell group that has a terminal voltage higher than that of the other battery cells can be selectively discharged through the corresponding discharging section. This allows the state of charge of the plurality of battery cells in each battery cell group to be equalized. Further, a battery cell group among the plurality of battery cell groups that has terminal voltage in each of its battery cells that is lower than that of the other battery cell groups can be selectively charged by the corresponding charging section. This allows battery cell state of charge equalization among the plurality of battery cell groups.

The time required to equalize the state of charge of the plurality of battery cells in each battery cell group by cell discharging is less than the time required to equalize the state of charge of all the battery cells in the plurality of battery cell groups by cell discharging. Further, equalizing the state of charge of a plurality of battery cells by charging can be performed quicker than equalizing the state of charge of the plurality of battery cells by discharging.

Consequently, compared to equalizing the state of charge of all the battery cells by discharging, equalization of all the battery cells can be performed more efficiently by equalizing the state of charge of the plurality of battery cells in each battery cell group by discharging, and equalizing the plurality of battery cell groups by charging.

Further, since a single charging section is established for each battery cell group, which includes a plurality of battery cells, the number of charging sections is reduced compared to establishing a plurality of charging sections corresponding to each of the plurality of battery cells. This constrains the scale of the charging circuitry and prevents it from becoming oversized.

The charging circuitry can include a first coil connected to a power supply, a plurality of second coils established in one-to-one correspondence with the plurality of battery cell groups to serve as charging sections with current flow induced by magnetic field variation in the first coil, and a plurality of first switches that operate independently for each of the plurality of second coils to switch between induced current flow and no induced current flow in each second coil.

This allows induced current from the first coil to be selectively induced in the second coils. Accordingly, a battery cell group with terminal voltages in each of its battery cells that are lower than those of other battery cell groups can be selectively charged. As a result, the state of charge of the plurality of battery cell groups can be equalized using a simple structure.

The first coil can be connected to a plurality of battery cell groups as its power supply.

This allows battery cell groups to be selectively charged using a simple structure and without using another power supply.

The first coil can be connected to a power supply that is different from the plurality of battery cell groups.

This allows battery cell groups to be selectively charged without reducing the terminal voltages of battery cells in the plurality of battery cell groups.

The charging circuitry can be configured to allow periodic switching between current flow and no current flow from the power supply to the first coil.

Switching with a given periodicity between current flow and no current flow from the power supply to the first coil enables the magnetic field of the first coil to be continuously varied. This allows induced current to flow continuously in selected second coils and allows the corresponding battery cell groups to be charged in a short time interval.

The discharging sections can include a plurality of resistors established in one-to-one correspondence with each of the plurality of battery cells in the plurality of battery cell groups, and a plurality of second switches that can independently switch between electrical connection and disconnection for each resistor and its corresponding battery cell terminals.

This allows resistors to be selectively connected to the battery cells. Accordingly, a battery cell that has higher terminal voltage than the other battery cells can be selectively discharged. As a result, the state of charge of the battery cells in each battery cell group can be equalized with a simple structure.

An equalizing apparatus for another aspect of the present invention equalizes the state of charge of a plurality of series-connected battery cells included in each of a plurality of battery cell groups. The equalizing apparatus includes a plurality of discharging sections established in one-to-one correspondence with each of the plurality of battery cells in the plurality of battery cell groups, and charging circuitry having a plurality of charging sections established in one-to-one correspondence with each of the plurality of battery cell groups. Each discharging section is connected across the terminals of the corresponding battery cell, and each charging section is connected between the highest and lowest potential battery cell terminals of the corresponding battery cell group.

In this equalizing apparatus, each of the plurality of discharging sections is connected across the terminals of the corresponding battery cell. Each of the plurality of charging sections in the charging circuitry is connected between the highest potential battery cell terminal and the lowest potential battery cell terminal in the corresponding battery cell group.

A battery cell among the plurality of battery cells in each battery cell group that has a terminal voltage higher than that of the other battery cells can be selectively discharged through the corresponding discharging section. This allows the state of charge of the plurality of battery cells in each battery cell group to be equalized. Further, a battery cell group among the plurality of battery cell groups that has terminal voltage in each of its battery cells that is lower than that of the other battery cell groups can be selectively charged by the corresponding charging section. This allows battery cell state of charge equalization among the plurality of battery cell groups.

The time required to equalize the state of charge of the plurality of battery cells in each battery cell group by cell discharging is less than the time required to equalize the state of charge of all the battery cells in the plurality of battery cell groups by cell discharging. Further, equalizing the state of charge of a plurality of battery cells by charging can be performed quicker than equalizing the state of charge of the plurality of battery cells by discharging.

Consequently, compared to equalizing the state of charge of all the battery cells by discharging, equalization of all the battery cells can be performed more efficiently by equalizing the state of charge of the plurality of battery cells in each battery cell group by discharging, and equalizing the plurality of battery cell groups by charging.

Further, since a single charging section is established for each battery cell group, which includes a plurality of battery cells, the number of charging sections is reduced compared to establishing a plurality of charging sections corresponding to each of the plurality of battery cells. This constrains the scale of the charging circuitry and prevents it from becoming oversized.

An equalizing system for another aspect of the present invention is provided with the previously described battery system for one aspect of the present invention, and a control section that controls the charging circuitry and the plurality of discharging sections in the battery system.

In the equalizing system, the charging circuitry and the plurality of discharging sections in the previously described battery system are controlled by the control section. This allows equalization of the state of charge of all the plurality of series-connected battery cells included in the plurality of battery cell groups. Since this equalizing system uses the previously described battery system, the state of charge of all battery cells can be efficiently equalized while constraining the size of the charging circuitry.

The control section can control the charging circuitry and the plurality of discharging sections to equalize the state of charge of the plurality of battery cell groups after the state of charge in each battery cell group has been equalized.

In this case, battery cells in each battery cell group are selectively discharged to equalize the state of charge of the plurality of battery cells in each battery cell group. Subsequently, by selectively charging battery cell groups, the state of charge can be equalized for all the battery cells. This allows the state of charge of all the battery cells to be accurately and efficiently equalized.

Further, since battery cell groups are selectively charged to an equalized condition with no state of charge variation between battery cell groups, over-charging of individual battery cells is prevented.

An electric-powered vehicle for another aspect of the present invention is provided with the previously described equalizing system for another aspect of the present invention, a motor driven by power from the equalizing system, and driving wheel(s) rotated by torque from the motor.

In this electric-powered vehicle, the motor is operated with power from the previously described equalizing system. The electric-powered vehicle is driven by rotating the driving wheel(s) with torque produced by the motor. Since the previously described equalizing system is used, the state of charge of all the battery cells can be efficiently equalized while constraining the size of the charging circuitry. As a result, electric-powered vehicle reliability can be improved without making the vehicle oversized.

Electric-powered movable equipment for another aspect of the present invention is provided with the previously described equalizing system for another aspect of the present invention, a main unit of the movable equipment, a mechanical power source that receives electric power from the equalizing system and converts it to mechanical power, and a driving section that moves the main unit of the movable equipment with mechanical power converted from electric power by the mechanical power source.

In this electric-powered movable equipment, electric power from the previously described equalizing system is converted to mechanical power by the mechanical power source, and that mechanical power is used by the driving section to move the main unit of the movable equipment. Since the previously described equalizing system is used, the state of charge of all the battery cells can be efficiently equalized while constraining the size of the charging circuitry. As a result, reliability of the electric-powered movable equipment can be improved without making it oversized.

A power storage device for another aspect of the present invention is provided with the previously described equalizing system for another aspect of the present invention, and a system control section to control charging and discharging of the plurality of battery cells in the equalizing apparatus.

In this power storage device, control relating to charging and discharging the plurality of battery cells is performed by the system control section. This allows over-charging, over-discharging, and degradation of the plurality of battery cells to be avoided. Further, since the previously described equalizing system is used, the state of charge of all the battery cells can be efficiently equalized while constraining the size of the charging circuitry. As a result, reliability of the power storage device can be improved without making the device oversized.

A power source apparatus for another aspect of the present invention is a power source apparatus that can connect with external systems and is provided with the previously described power storage device for another aspect of the present invention, and with a power conversion device that is controlled by the power storage device system control section to perform power conversion between the plurality of battery cells in the power storage device and external systems.

In this power source apparatus, power conversion between the plurality of battery cells and the external systems is performed by the power conversion device. By controlling the power conversion device with the system control section in the power storage device, control relating to charging and discharging the plurality of battery cells can be performed. This allows over-charging, over-discharging, and degradation of the plurality of battery cells to be avoided. Further, since the previously described equalizing system is used, the state of charge of all the battery cells can be efficiently equalized while constraining the size of the charging circuitry. As a result, reliability of the power source apparatus can be improved without making the apparatus oversized.

The present invention allows the state of charge of the plurality of battery cells to be equalized in an efficient manner.

### BRIEF DESCRIPTION OF THE DRAWINGS

FIG. 1 is a block diagram showing the structure of an equalizing apparatus, and a battery system and equalizing system employing that equalizing apparatus for the first embodiment of the present invention;

FIG. 2 is a timing diagram to explain the first example of the second equalizing operation;

FIG. 3 is a flowchart showing voltage detection section control operations during the first equalizing operation;

FIG. 4 is a flowchart showing battery ECU control operations during the second equalizing operation;

FIG. 5 is a timing diagram to explain the second example of the second equalizing operation;

FIG. 6 is a timing diagram to explain the third example of the second equalizing operation;

FIG. 7 is a block diagram showing the structure of an equalizing apparatus, and a battery system and equalizing system employing that equalizing apparatus for the second embodiment of the present invention;

FIG. 8 is a timing diagram to explain the second equalizing operation for the equalizing system of FIG. 7;

FIG. 9 is a block diagram showing the structure of an electric automobile for the third embodiment; and

FIG. 10 is a block diagram showing the structure of a power source apparatus for the fourth embodiment.

### DETAILED DESCRIPTION OF THE EMBODIMENTS

The following describes embodiments of the equalizing apparatus of the present invention, and a battery system, equalizing system, electric-powered vehicle, electric-powered movable equipment, power storage device, and power source apparatus equipped with the equalizing apparatus.

### (1) First Embodiment

### (1-1) Equalizing System Structure

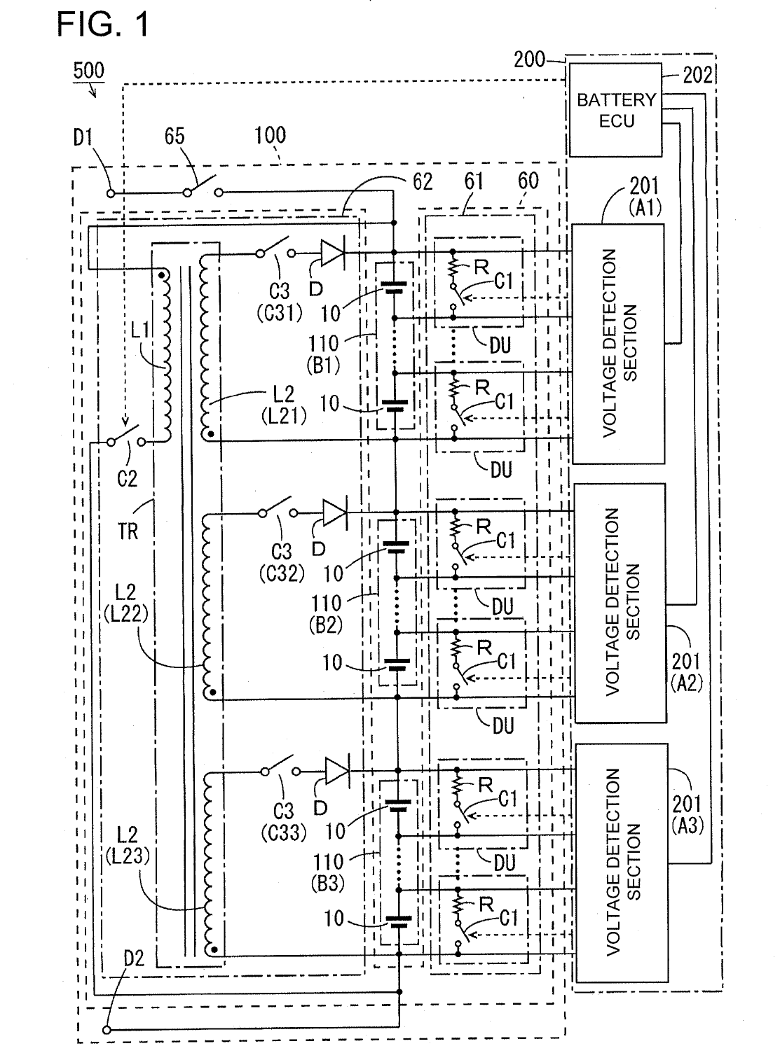

FIG. 1 is a block diagram showing the structure of an equalizing apparatus, and a battery system and equalizing system equipped with that equalizing apparatus for the first embodiment of the present invention. As shown in FIG. 1, the equalizing system 500 is provided with the battery system 100 and a control section 200.

The battery system 100 includes a plurality of (three in the present example) battery cell groups 110, an equalizing apparatus 60, and a contactor (high-power switching relay) 65. The plurality of battery cell groups 110 are connected in series. Each battery cell group 110 includes a plurality of series-connected battery cells 10. Each battery cell 10 is a rechargeable battery, and for example, lithium ion batteries are used as the battery cells 10. In the following, the positive electrode terminal and negative electrode terminal of each battery cell 10 is generically referred to as a battery cell terminal. The highest potential battery cell terminal and the lowest potential battery cell terminal (D1 and D2 in FIG. 1) of the plurality of battery cell groups 110 are connected to the load (not illustrated). The contactor 65 is connected between the highest potential battery cell terminal and the load.

The equalizing apparatus 60 includes discharging circuitry 61 and charging circuitry 62. The discharging circuitry 61 includes a plurality of discharging sections DU corresponding to each of the plurality of battery cells 10 in the plurality of battery cell groups 110. Each discharging section DU includes a series-connected resistor R and switching device C1, and each of those series circuits is connected across the terminals of each battery cell 10.

The charging circuitry 62 includes a primary coil L1, a switching device C2, a plurality of secondary coils L2, a plurality of switching devices C3, and a plurality of diodes D. One end of the primary coil L1 is connected to highest potential battery cell terminal in the plurality of battery cell groups 110, and the other end is connected through the switching device C2 to the lowest potential battery cell terminal in the plurality of battery cell groups 110. The plurality of secondary coils L2, plurality of switching devices C3, and plurality of diodes D are established corresponding to each of the plurality of battery cell groups 110. One end of each secondary coil L2 is connected to the highest potential battery cell terminal in the corresponding battery cell group 110 through a switching device C3 and diode D, and the other end is connected to the lowest potential battery cell terminal in the corresponding battery cell group 110. A transformer TR is formed by the primary coil L1 and the plurality of secondary coils L2. The polarity of each of the plurality of secondary coils L2 is opposite the polarity of the primary coil L1.

The control section 200 includes a plurality of voltage detection sections 201 and a battery electronic control unit (ECU) 202. The plurality of voltage detection sections 201 are established corresponding to each of the plurality of battery cell groups 110. Each voltage detection section 201 is implemented, for example, by an application specific integrated circuit (ASIC). Each voltage detection section 201 is connected to the terminals of the plurality of battery cells 10 in the corresponding battery cell group 110. The battery ECU 202 is implemented, for example, by a central processing unit (CPU) and memory, or a microcomputer (or microcontroller). The battery ECU 202 is connected to the plurality of voltage detection sections 201.

Each voltage detection section 201 detects voltage at the terminals of each battery cell 10 in the corresponding battery cell group 110 and controls the switching devices C1 in the corresponding discharging sections DU ON and OFF based on the detected terminal voltages. Each voltage detection section 201 also controls the corresponding switching device C3 ON and OFF according to instructions from the battery ECU 202. Further, each voltage detection section 201 outputs detected terminal voltage values to the battery ECU 202. The battery ECU 202 controls the switching device C2 ON and OFF based on the terminal voltage values input from the plurality of voltage detection sections 201 and outputs ON and OFF instructions for each switching device C3 to each voltage detection section 201. The battery ECU 202 also switches the contactor 65 OFF if an abnormality develops in the battery system 100. If the contactor 65 is switched OFF, there is no current flow between the plurality of battery cell groups 110 and the load. This allows abnormal heating of the plurality of battery cell groups to be prevented.

In the following, battery cell groups 110 are labeled B1, B2, and B3 in order from the highest potential battery cell group 110 (B1) to the lowest potential battery cell group 110 (B3). Similarly, the three secondary coils L2, the three switching devices C3, and the three voltage detection sections 201 corresponding to the battery cell groups B1-B3 are labeled secondary coils L21-L23, switching devices C31-C33, and voltage detection sections A1-A3 respectively.

Although there are three battery cell groups 110 in the present embodiment, battery cell groups are not limited to that configuration, and there can also be two battery cell groups or four or more battery cell groups. Further, the number of battery cells 10 included in each battery cell group 110 can be uniform or can be a different number in each battery cell group.

In the present embodiment, each voltage detection section 201 controls corresponding discharging section DU switching devices C1 and the corresponding switching device C3 ON and OFF, and the battery ECU 202 controls the switching device C2 and the contactor 65 ON and OFF. However, the system is not limited to that configuration. It is also possible for the battery ECU 202 to control each discharging section DU switching device C1 and each switching device C3 ON and OFF based on terminal voltage values input from the voltage detection sections 201, and it is also possible for one of the voltage detection sections 201 to control the switching device C2 and the contactor 65 ON and OFF.

### (1-2) Equalizing Process

In the equalizing system 500 in FIG. 1, the state of charge of all the battery cells 10 in the battery cell groups B1-B3 are equalized by the equalizing apparatus 60. The state of charge is indicated, for example, by terminal voltage, battery charge level (state of charge, SOC), remaining charge capacity, depth of discharge (DOD), integrated current value or accumulated charge difference. In the present embodiment, terminal voltage equalization is performed to equalize the state of charge.

The equalizing process has a first equalizing operation that equalizes battery cells 10 in each battery cell group B1-B3, and a second equalizing operation that equalizes the plurality of battery cell groups B1-B3. In the present embodiment, the second equalizing operation is performed after the first equalizing operation.

The following describes the first equalizing operation for battery cell group B1. When the terminal voltage of one battery cell 10 is greater than the terminal voltages of the other battery cells 10 in battery cell group B1, the switching device C1 in the discharging section DU corresponding to that battery cell 10 is switched ON. Accordingly, charge in that high terminal voltage battery cell 10 is discharged through resistor R. When the terminal voltage of that battery cell 10 decreases and becomes approximately equal to the terminal voltages of the other battery cells 10, the switching device C1 in the discharging section DU corresponding to that battery cell 10 is switched OFF. By repeating this operation, the terminal voltages of the plurality of battery cells 10 in battery cell group B1 are equalized.

First equalizing operations are performed in the same manner in battery cell groups B2 and B3. This equalizes the terminal voltages of the plurality of battery cells 10 in battery cell group B2 and in battery cell group B3.

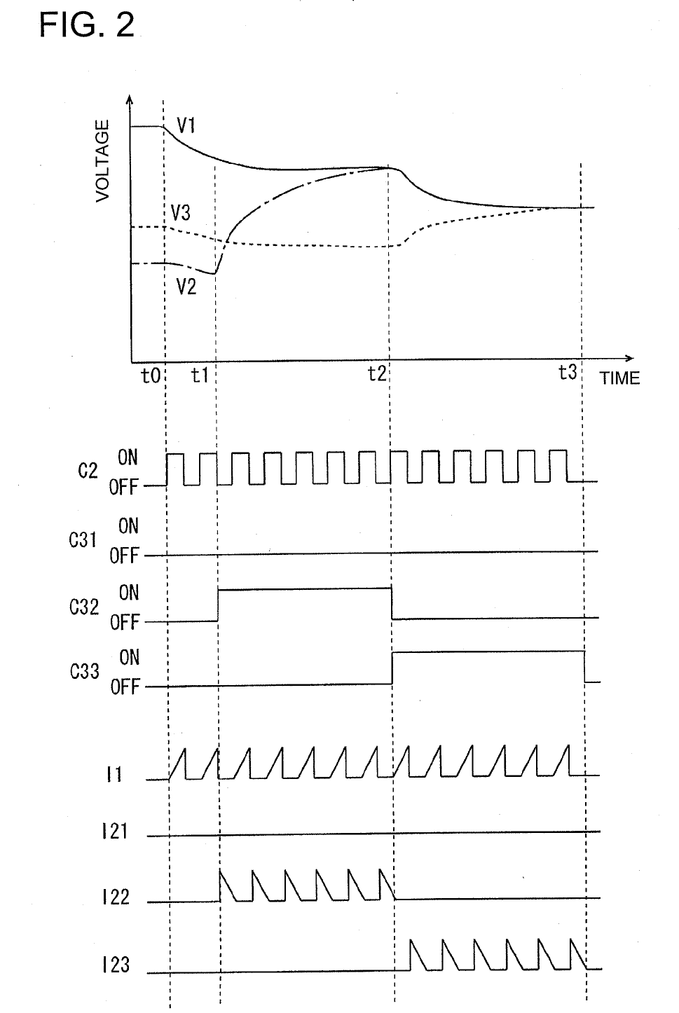

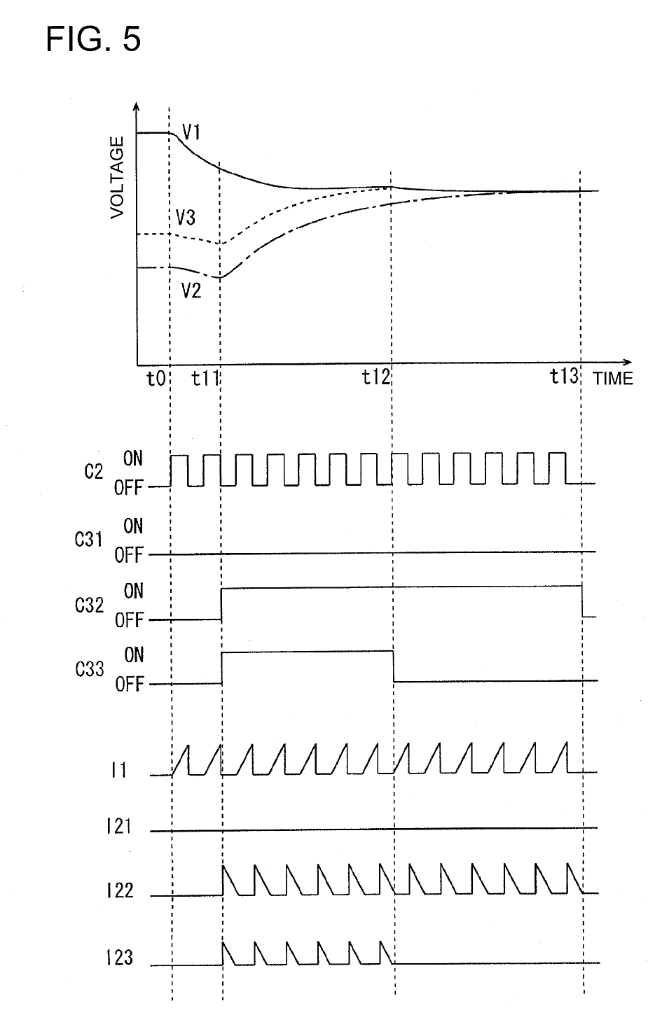

The following describes the second equalizing operation for equalization between battery cell groups B1-B3. FIG. 2 is a timing diagram to explain the first example of the second equalizing operation. FIG. 2 and subsequently described FIGS. 5, 6, and 8 show battery cell 10 terminal voltages in the battery cell groups B1-B3, the ON or OFF state of switching devices C2, C31-C33, and current flow in the primary coil L1 and in the secondary coils L21-L23.

For the second equalizing operation, the terminal voltages of the plurality of battery cells 10 in each of the battery cell groups B1-B3 are maintained at approximately equalized voltages. In the following, the terminal voltage of the battery cells 10 in battery cell group B1 is referred to as terminal voltage V1, the terminal voltage of the battery cells 10 in battery cell group B2 is referred to as terminal voltage V2, and the terminal voltage of the battery cells 10 in battery cell group B3 is referred to as terminal voltage V3. Further, in the figures, current flow in the primary coil L1 is labeled I1, and currents in the secondary coils L21-L23 are labeled I21-I23.

In the example of FIG. 2, the second equalizing operation begins at time t0. Prior to the start of the second equalizing operation, terminal voltage V3 is greater than terminal voltage V2 and terminal voltage V1 is greater than terminal voltage V3. Further, the switching devices C2, C31-C33 are all in the OFF state.

When the second equalizing operation is initiated, switching device C2 is switched ON and OFF with given periodicity. Accordingly, periodic pulse current flows from the highest potential battery cell terminal in the battery cell groups B1-B3 through the primary coil L1 to the lowest potential battery cell terminal. As a result, each of the battery cell groups B1-B3 is discharged and the terminal voltages V1-V3 gradually decrease.

At time t1, switching device C32 is switched ON. Accordingly, induced current flows in the secondary coil L22 due to pulse current flow in the primary coil L1. In this case, (induced pulse) current flows through battery cell group B2 from the lowest potential battery cell terminal to the highest potential battery cell terminal. As a result, battery cell group B2 is charged and terminal voltage V2 gradually rises.

At time t2, terminal voltages V1 and V2 become essentially equal. Meanwhile, terminal voltage V3 is lower than terminal voltages V1 and V2. Accordingly, switching device C32 is switched OFF and switching device C33 is switched ON. This stops induced current from flowing through secondary coil L22, and terminal voltage V2 gradually decreases along with terminal voltage V1. In contrast, induced current flows through secondary coil L23. As a result, terminal voltage V3 gradually rises.

At time t3, terminal voltages V1-V3 become essentially equal. At that point, switching devices C2 and C33 are switched OFF completing the second equalizing operation.

In this manner, except for the battery cell group B1 with the highest terminal voltage (referred to below as the reference battery cell group), the other battery cell groups B2 and B3 are sequentially charged by current induced via the transformer TR. This equalizes terminal voltages between battery cell groups B1-B3. As a result, the terminal voltages of all the battery cells 10 are equalized. In the present example, the battery cell group B2 with the lowest terminal voltage at the beginning of the second equalizing operation was charged first. However, operation is not limited to that sequence and the order of charging for battery cell groups other than the reference battery cell group can be arbitrary.

### (1-3) Control Section Operation

During the first equalizing operation, the plurality of switching devices C1 in each battery cell group B1-B3 are switched ON and OFF by the corresponding voltage detection section A1-A3. During the second equalizing operation, the switching devices C2, C31-C33 are controlled by the battery ECU 202 and the voltage detection sections A1-A3. The following describes the control operations of the voltage detection sections A1-A3 and battery ECU 202.

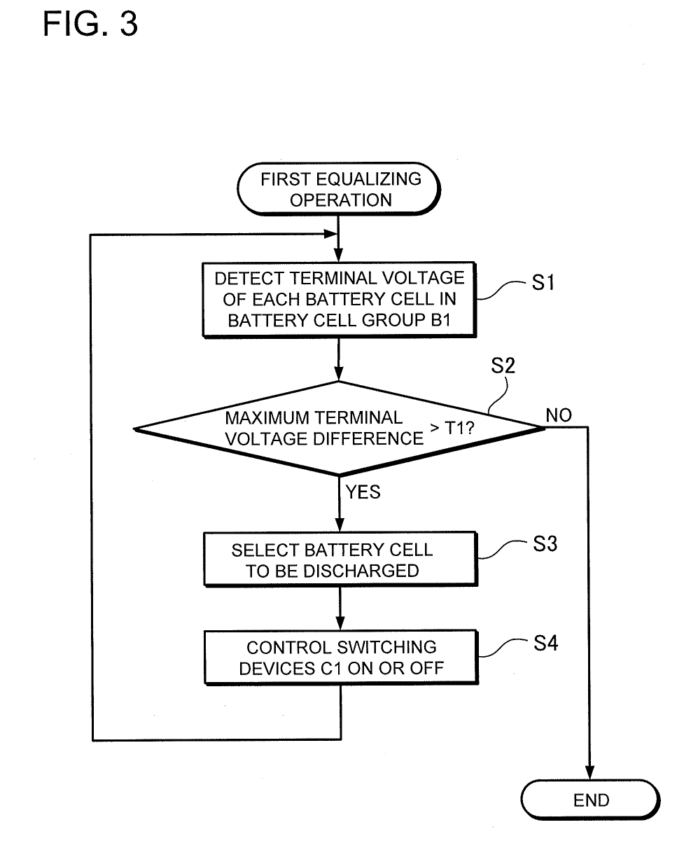

FIG. 3 is a flowchart showing voltage detection section A1 control operations during the first equalizing operation. All the switching devices C1 in battery cell group B1 are initially in the OFF state. As shown in FIG. 3, the voltage detection section A1 first detects the terminal voltage of each battery cell 10 in battery cell group B1 (step S1). Next, the voltage detection section A1 determines whether or not the difference between the highest detected terminal voltage and the lowest detected terminal voltage (referred to below as the maximum terminal voltage difference) is greater than a predetermined threshold value T1 (step S2).

When the maximum terminal voltage difference is greater than the threshold value T1, the voltage detection section A1 selects the battery cell 10 from the plurality of battery cells 10 in battery cell group B1 that should be discharged based on the detected terminal voltages (step S3). Next, the voltage detection section A1 controls the plurality of switching devices C1 in battery cell group B1 ON or OFF to discharge the selected battery cell 10 (step S4). In this case, the switching device C1 corresponding to the selected battery cell 10 is switched ON, and switching devices C1 corresponding to the unselected battery cells 10 are maintained in the OFF state.

Subsequently, steps S1-S4 are repeated until the maximum terminal voltage difference becomes less than or equal to the threshold value T1. When the maximum terminal voltage difference becomes less than or equal to the threshold value T1, the voltage detection section A1 switches OFF all the switching devices C1 in battery cell group B1 and ends the first equalizing operation.

Voltage detection sections A2 and A3 operate in the same manner as voltage detection section A1 shown in FIG. 3. Accordingly, by controlling the plurality of switching devices C1 ON and OFF with the voltage detection sections A1-A3, the terminal voltages of the plurality of battery cells 10 in each battery cell group B1-B3 are equalized.

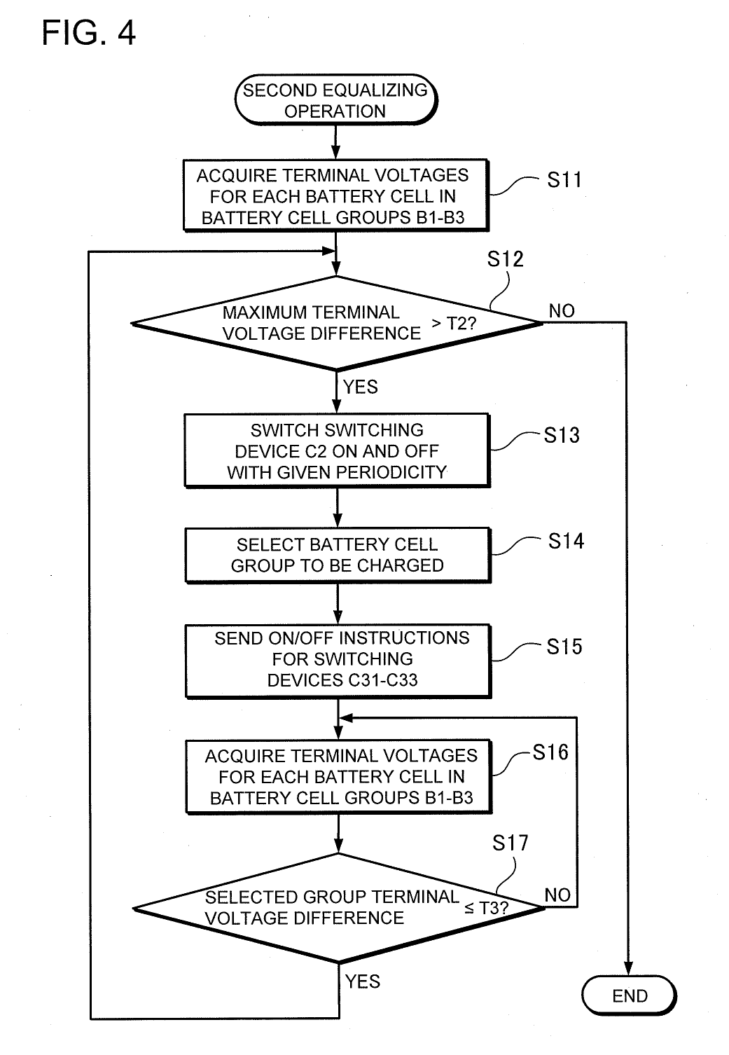

FIG. 4 is a flowchart showing battery ECU 202 control operations during the second equalizing operation. The initial state has switching devices C2, C31-C33 in the OFF state.

As shown in FIG. 4, The battery ECU 202 first acquires the terminal voltage of each battery cell 10 in the battery cell groups B1-B3 from the voltage detection sections A1-A3 (step S11). In this case, the terminal voltages of the plurality of battery cells 10 in a single battery cell group B1, B2, or B3 are approximately equal.

Next, the battery ECU 202 determines whether or not the difference between the detected terminal voltages (referred to below as the maximum terminal voltage difference) is greater than a predetermined threshold value T2 (step S12). The threshold value T2 is, for example, equal to the threshold value T1. When the maximum terminal voltage difference is greater than the threshold value T2, the battery ECU 202 switches the switching device C2 ON and OFF with a given periodicity (step S13).

Next the battery ECU 202 selects the battery cell group that should be charged based on the detected terminal voltage values (step S14). The battery ECU 202 sends switching device C31-C33 ON/OFF instructions to each voltage detection section A1-A3 to charge the selected battery cell group (step S15). In this case, the switching device C31, C32, or C33 corresponding to the selected battery cell group is switched ON, and switching devices corresponding to the unselected battery cell groups are maintained in the OFF state.

Next, the battery ECU 202 acquires the terminal voltage values for each battery cell 10 in the battery cell groups B1-B3 from the voltage detection sections A1-A3 (step S16). The battery ECU 202 determines whether or not the difference between the highest detected terminal voltage and the terminal voltage of battery cells 10 in the battery cell group selected in step S14 (referred to below as the selected group terminal voltage difference) is less than or equal to a predetermined threshold value T3 (step S17). The threshold value T3 is, for example, less than the threshold value T2. When the selected group terminal voltage difference is greater than the threshold value T3, the battery ECU 202 repeatedly loops through steps S16 and S17 until the selected group terminal voltage difference becomes less than or equal to threshold value T3. When the selected group terminal voltage difference becomes less than or equal to threshold value T3, battery ECU 202 control returns to step S12.

Subsequently, the battery ECU 202 repeatedly loops through steps S12-S17 until the maximum terminal voltage difference becomes less than or equal to the threshold value T2. When the maximum terminal voltage difference becomes less than or equal to the threshold value T2, the battery ECU 202 switches OFF the switching devices C2, C31-C33 and ends the second equalizing operation.

In this manner, by controlling the switching devices C2, C31-C33 ON and OFF with the battery ECU 202 and voltage detection sections A1-A3, equalization is achieved between the battery cell groups B1, B2, and B3. As a result, terminal voltages of all the battery cells 10 are equalized.

### (1-4) Effectiveness

In the present embodiment, terminal voltages in each battery cell group 110 are equalized by selectively discharging battery cells 10 with the discharging circuitry 61. Further, terminal voltage is equalized among the plurality of battery cell groups 110 by selectively charging battery cell groups 110 with the charging circuitry 62.

The time required to equalize the terminal voltages in each battery cell group 110 by discharging is less than the time required to equalize the terminal voltages of all the battery cells 10 by discharging. Further, equalizing the terminal voltages of a plurality of battery cells 10 by charging can be performed in a shorter time than equalizing the terminal voltages of the plurality of battery cells 10 by discharging.

Consequently, compared to equalizing the terminal voltages of all the battery cells 10 by discharging, equalizing the terminal voltages of all the battery cells 10 can be performed more efficiently by equalizing terminal voltages in each battery cell group 110 by discharging, and equalizing terminal voltage between the plurality of battery cell groups 110 by charging.

Further, to equalize the terminal voltages of all the battery cells 10 by charging, a secondary coil L2 must be provided for each battery cell 10. In that case, the number of secondary coils L2 becomes considerable and the charging circuitry 62 becomes oversized. In contrast, since the present embodiment establishes a single secondary coil L2 for each battery cell group 110, the number of secondary coils L2 is kept low. This constrains the size of the charging circuitry 62.

In the present embodiment, the second equalizing operation is performed after the first equalizing operation has been performed in each battery cell group 110. If instead the first equalizing operation is performed after the second equalizing operation, it is possible for variation between the plurality of battery cell groups 110 to reoccur. Also in this case, since the second equalizing operation is performed with terminal voltage variation in each of the battery cell groups 110, it is possible for a battery cell 10 with relatively high terminal voltage to become over-charged during the second equalizing operation. In contrast, when the second equalizing operation is performed after the first equalizing operation, terminal voltage is equalized between the plurality of battery cell groups 110 after terminal voltages have been equalized in each battery cell group 110. This allows the terminal voltages of all the battery cells 10 to be equalized with precision. Further, since the second equalizing operation is performed with equalized terminal voltages in each battery cell group 110, over-charging of individual battery cells 10 is prevented.

In the present embodiment, the primary coil L1 uses the plurality of battery cell groups 110 as its power supply. Consequently, the plurality of battery cell groups 110 can be selectively charged using a simple structure and without using a separate power supply.

### (1-5) Second Example of the Second Equalizing Operation

FIG. 5 is a timing diagram to explain the second example of the second equalizing operation. The initial state for the example in FIG. 5 is the same as the initial state for the example in FIG. 2. The following describes elements of the FIG. 5 example that are different from those of the FIG. 2 example.

In the example of FIG. 5, switching devices C32, C33 are switched ON at time t11. This produces induced current flow in the secondary coils L22, L23 due to pulse current in the primary coil L1, and charges the battery cell groups B2, B3. Of the two secondary coils L22, L23, more induced current flows in the secondary coil corresponding to the battery cell group with lower terminal voltage. In the present example, induced current flow in secondary coil L22 is greater than that in secondary coil L23. As a result, the difference between terminal voltage V2 and terminal voltage V3 decreases gradually.

At time t12, when the terminal voltages V1, V3 become approximately equal, switching device C33 is switched OFF to stop battery cell group B3 charging. At time t13, when the terminal voltages V1, V2 and V3 all become approximately equal, switching devices C2, C32 are switched OFF to stop battery cell group B2 charging. This completes the second equalizing operation.

In this manner, except for the reference battery cell group, the plurality of battery cell groups are charged simultaneously in the second example. Battery cell group charging is stopped in the order that terminal voltage becomes approximately equal to the reference battery cell group terminal voltage. This allows terminal voltages to be equalized more efficiently for the plurality of battery cell groups.

### (1-6) Third Example of the Second Equalizing Operation

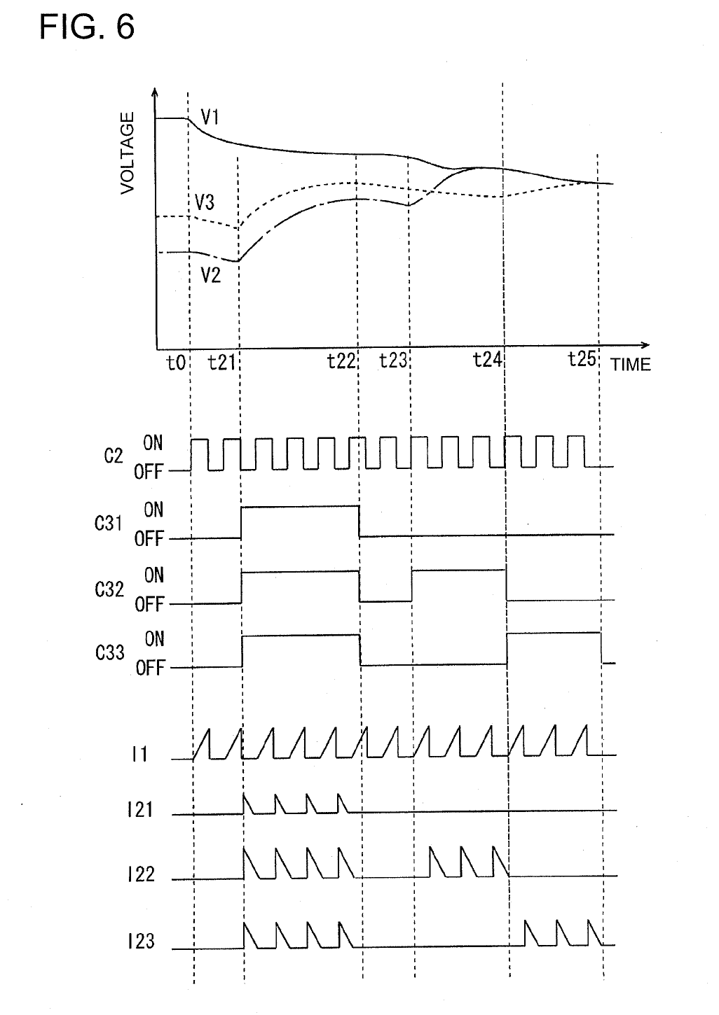

FIG. 6 is a timing diagram to explain the third example of the second equalizing operation. The initial state for the example in FIG. 6 is the same as the initial state for the example in FIG. 2. The following describes elements of the FIG. 6 example that are different from those of the FIG. 2 example.

In the example of FIG. 6, switching devices C31-C33 are all switched ON at time t21. This induces current from the primary coil L1 in all the secondary coils L21-L23, and charges the battery cell groups B1-B3.

As described previously, more induced current flows in a secondary coil corresponding to a battery cell group with lower terminal voltage. In the present example, more induced current flows in secondary coil L23 than in secondary coil L21, and more induced current flows in secondary coil L22 than in secondary coil L23. In this case, the amount of charge discharged by battery cell group B1 is greater than the amount of charge it is supplied with. Therefore, terminal voltage V1 gradually decreases. In contrast, charge supplied to battery cell groups B2 and B3 is greater than the amount discharged. Consequently, terminal voltages V2 and V3 gradually increase. Further, the difference between the terminal voltages V2, V3 gradually decreases.

When the maximum terminal voltage difference drops below a predetermined threshold value, the switching devices C31-C33 are switched OFF. In the present example, the difference between terminal voltages V1 and V2 becomes less than the threshold value at time t22, and the switching devices C31-C33 are switched OFF.

Subsequently, except for the battery cell group with the highest terminal voltage, battery cell groups are sequentially charged in the same manner as the first example. In the present example, switching device C32 is switched ON at time t23 to charge battery cell group B2. At time t24, terminal voltages V1 and V2 are approximately equal, switching device C32 is switched OFF, and switching device C33 is switched ON. This stops charging of battery cell group B2 and begins charging of battery cell group B3. At time t25 when all the terminal voltages V1-V3 become approximately equal, switching devices C2, C33 are switched OFF and battery cell group charging is stopped. This completes the second equalizing operation.

In this third example, initially all the battery cell groups are charged simultaneously. When the maximum terminal voltage difference of all the battery cell groups drops below the threshold value, battery cell groups other than the reference battery cell group are charged sequentially. This allows more efficient terminal voltage equalization for the plurality of battery cell groups.

Note that after the maximum terminal voltage difference of all the battery cell groups drops below the threshold value, battery cell groups other than the reference battery cell group can be charged simultaneously as previously described in the second example instead of sequentially as in the first example.

### (2) Second Embodiment

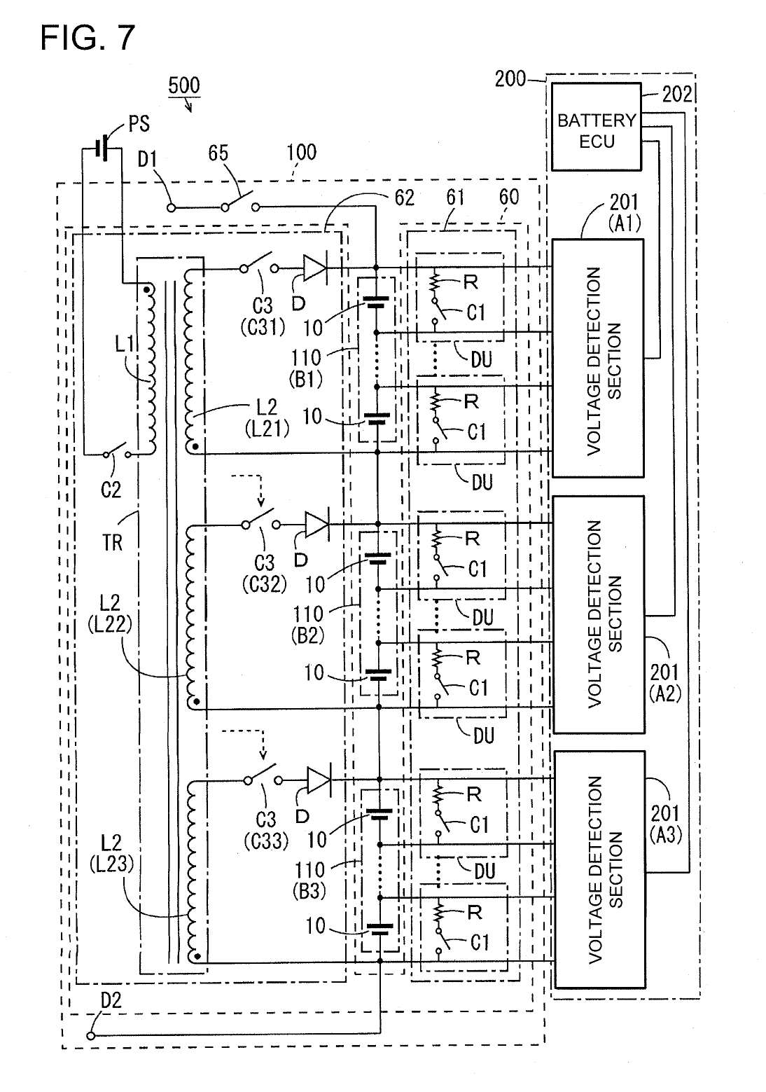

FIG. 7 is a block diagram showing the structure of an equalizing apparatus, and a battery system and equalizing system employing that equalizing apparatus for the second embodiment of the present invention. The following describes differences between the equalizing system 500 of FIG. 1 and the equalizing system 500 of FIG. 7.

In the equalizing system 500 of FIG. 7, one end of the primary coil L1 is connected to the positive terminal of an external power supply PS, and the other end is connected to the negative terminal of the external power supply PS through the switching device C2. When the switching device C2 is switched ON, current flows through the primary coil L1.

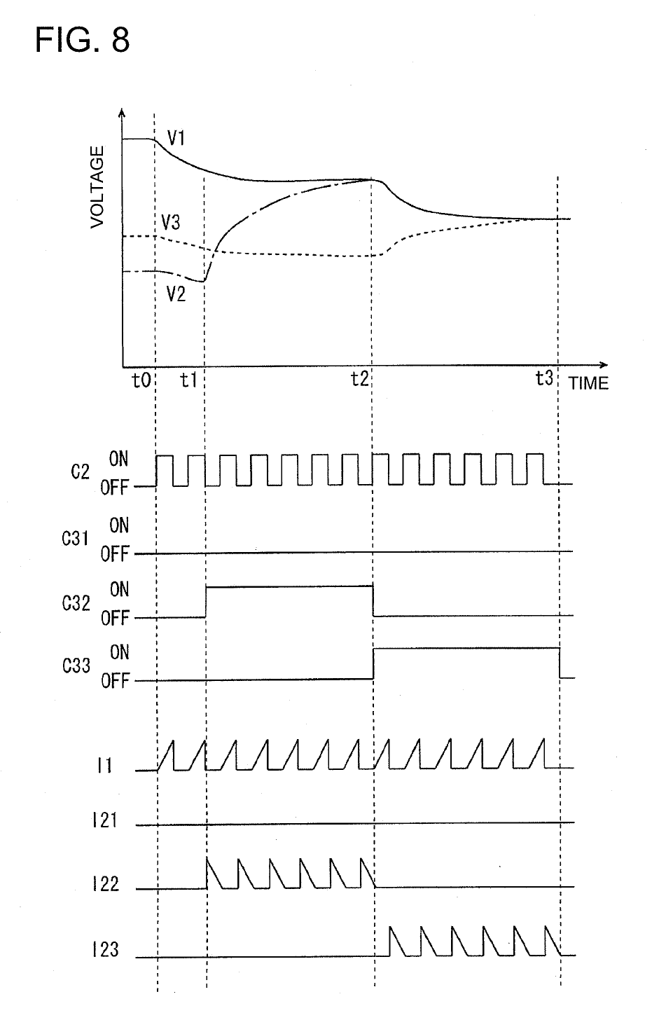

The following describes the equalization process for the equalizing system 500 of FIG. 7. The first equalizing operation is the same as the first equalizing operation described previously for the first embodiment. FIG. 8 is a timing diagram to explain the second equalizing operation for the equalizing system 500 of FIG. 7. The initial state for the example in FIG. 8 is the same as the initial state for the example in FIG. 2. The following describes elements of the FIG. 8 example that are different from those of the FIG. 2 example.

In the example of FIG. 8, no current flows from the battery cell groups B1-B3 to the primary coil L1 even when the switching device C1 is switched ON and OFF with given periodicity after time to. Consequently, the battery cell groups B1-B3 are not discharged and there is no decrease in the terminal voltages V1-V3.

At time t31, switching device C32 is switched ON. Accordingly, battery cell group B2 is charged and terminal voltage V2 gradually rises. At time t32, when terminal voltages V1 and V2 become approximately equal, switching device C32 is switched OFF and switching device C33 is switched ON. This stops battery cell group B2 charging and begins battery cell group B3 charging. At time t33, when all the terminal voltages V1-V3 become approximately equal, switching devices C2, C33 are switched OFF stopping battery cell group B3 charging. This completes the second equalizing operation.

In the present embodiment, battery cell groups B1-B3 can be selectively charged during the second equalizing operation without decreasing the terminal voltages V1-V3 of the battery cell groups B1-B3. This allows the terminal voltages to be equalized between battery cell groups B1-B3 in a simpler more precise manner.

The second equalizing operation for the equalizing system 500 in FIG. 7 can also be performed in the same manner as the example of FIG. 5 or in the same manner as the example of FIG. 6. In that case, equalization between the plurality of battery cell groups can be performed more efficiently.

In the equalizing systems 500 of FIGS. 1 and 7, a transformer TR is used as the charging circuitry. However, the charging circuitry is not limited to that configuration. For example, an external power supply and switching devices can be provided as charging circuitry for each of the battery cell groups 110, and the external power supply can be selectively connected to the battery cell groups 110 that should be charged. Or, a receiving coil can be connected to each battery cell group 110, and charging circuitry can be configured to selectively charge battery cell groups 110 that should be charged by a contactless method of power supply other than that using a transformer.

### (3) Third Embodiment

The following describes electric-powered movable equipment such as an electric-powered vehicle for the third embodiment. The electric-powered vehicle for the present embodiment is equipped with the equalizing system 500 for the first or second embodiments. An electric automobile is described below as one example of an electric-powered vehicle.

### (3-1) Structure and Operation

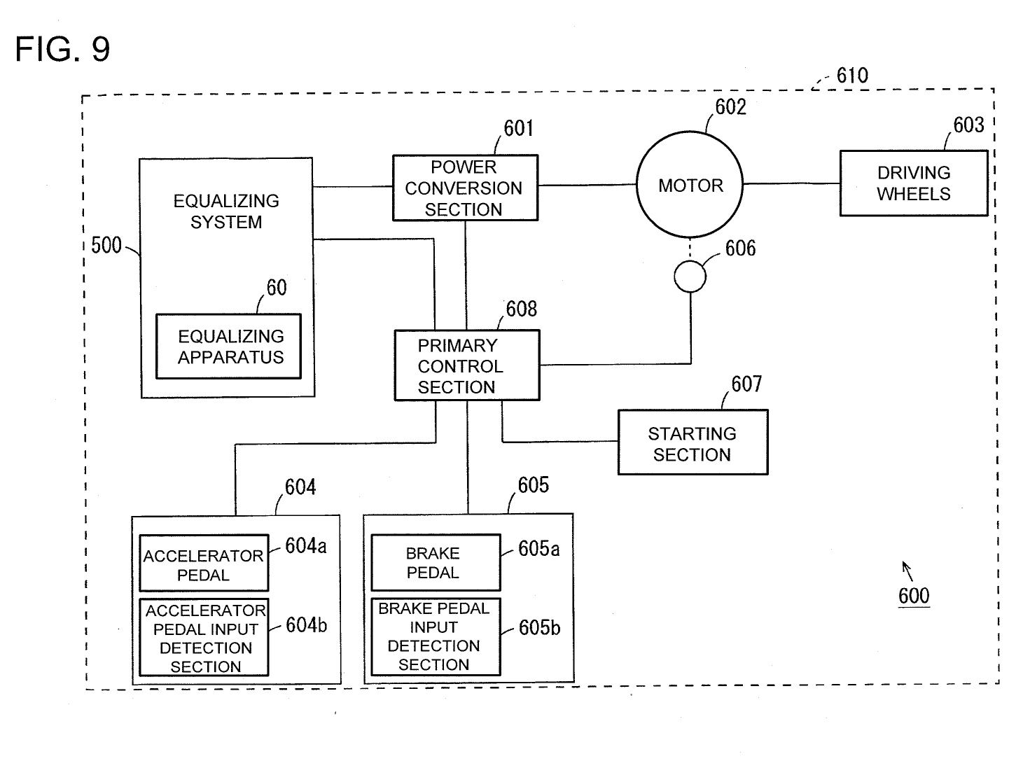

FIG. 9 is a block diagram showing the structure of an electric automobile for the third embodiment. As shown in FIG. 9, the electric automobile 600 is provided with a vehicle chassis 610. The vehicle chassis 610 is provided with the equalizing system 500 of FIG. 1 or FIG. 7, a power conversion section 601, a motor 602, driving wheel(s) 603, an accelerating device (accelerator) 604, a braking device 605, a rotation speed sensor (tachometer) 606, a starting section 607 and a primary control section 608. For the case where the motor 602 is an alternating current (AC) motor, the power conversion section 601 includes direct current-alternating current (DC/AC) inverter circuitry.

The equalizing system 500 is connected to the motor 602 through the power conversion section 601 and is also connected to the primary control section 608. The battery ECU 202 (refer to FIG. 1) in the equalizing system 500 computes the charge capacity of each battery cell 10 based on battery cell 10 terminal voltages.

The charge capacity of each battery cell 10 is input to the primary control section 608 from the battery ECU 202. In addition, the accelerating device 604, the braking device 605, the tachometer 606, and the starting section 607 are connected to the primary control section 608. The primary control section 608 is implemented by a device such as a CPU and memory, or a microcomputer.

The accelerating device 604 includes an accelerator pedal 604a installed in the electric automobile 600, and an accelerator pedal input detection section 604b to detect the amount of accelerator pedal input (the amount that the accelerator pedal is pressed).

When the ignition switch in the starting section 607 is ON and an operator presses the accelerator pedal 604a, the accelerator pedal input detection section 604b detects the amount of accelerator pedal 604a application compared to a reference state with no operator input. The detected amount of accelerator pedal 604a input is sent to the primary control section 608.

The braking device 605 includes a brake pedal 605a installed in the electric automobile 600, and a brake pedal input detection section 605b to detect the amount of brake pedal input (the amount that the brake pedal is pressed). When the ignition switch is ON and an operator presses the brake pedal 605a, the brake pedal input detection section 605b detects the amount of brake pedal application. The detected amount of brake pedal 605a input is sent to the primary control section 608. The tachometer 606 detects rotation speed of the motor 602. The detected rotation speed is input to the primary control section 608.

As described above, the charge capacity of each battery cell, the amount of accelerator pedal 604a application, the amount of brake pedal 605a application, and the motor 602 rotation speed is input to the primary control section 608. Based on that data, the primary control section 608 controls battery cell 10 charging and discharging, and controls power conversion by the power conversion section 601. For example, when the accelerator pedal is pressed during electric automobile 600 initial departure and acceleration, power from the plurality of battery cells 10 in the equalizing system 500 is supplied to the power conversion section 601.

In addition, the primary control section 608 computes the amount of torque that needs to be delivered (torque demand) to the driving wheel(s) 603 based on the amount of accelerator pedal 604a application, and issues a command signal to the power conversion section 601 based on the torque demand.

When the power conversion section 601 receives the command signal described above, it converts power supplied from the equalizing system 500 to (driving) power required to rotate the driving wheel(s) 603. As a result, driving power converted by the power conversion section 601 is supplied to the motor 602, and the motor 602 torque developed with that driving power is delivered to the driving wheel(s) 603.

In contrast, when the electric automobile 600 is decelerated by brake pedal application, the motor 602 serves as an electricity generating device (generator). In that case, the power conversion section 601 converts regenerative braking power generated by the motor 602 to power suitable for charging the plurality of battery cells 10, and delivers that power to the battery cells 10. As a result, the plurality of battery cells 10 are charged.

### (3-2) Effectiveness of the Third Embodiment

Since the electric automobile 600 for the third embodiment uses the equalizing system 500 of the first or second embodiment, the terminal voltages of all the battery cells 10 can be efficiently equalized while keeping the charging circuitry 62 from becoming oversized. Consequently, electric automobile 600 reliability can be improved while constraining the size of the electric automobile 600.

### (3-3) Other Electric-Powered Movable Equipment

The equalizing system 500 of the first or second embodiment can also be installed in movable equipment such as a boat, aircraft, elevator, or walking robot.

In a boat equipped with the equalizing system 500, a (boat) hull is provided, for example, instead of the vehicle chassis 610 in FIG. 9. A (boat) propeller is provided instead of driving wheel(s) 603, an acceleration input section is provided instead of an accelerating device 604, and a deceleration input section is provided instead of a braking device 605. The operator uses the acceleration input section instead of the accelerating device 604 to accelerate the boat, and uses the deceleration input section instead of the braking device 605 to decelerate the boat. In this case, the hull is the main unit of the movable equipment, an electric motor is the mechanical power source, and the propeller is the driving section. In this equipment configuration, the motor receives electrical power from the equalizing system 500, electrical power is converted to mechanical power, and the propeller is rotated by mechanical power to move the hull.

Similarly, in an aircraft equipped with the equalizing system 500, an airframe (fuselage, wings, and empennage) is provided, for example, instead of the vehicle chassis 610 in FIG. 9. An (aircraft) propeller is provided instead of driving wheel(s) 603, an acceleration input section is provided instead of an accelerating device 604, and a deceleration input section is provided instead of a braking device 605. In this case, the airframe is the main unit of the movable equipment, a motor is the mechanical power source, and the propeller is the driving section. In this equipment configuration, the motor receives electrical power from the equalizing system 500, electrical power is converted to mechanical power, and the propeller is rotated by mechanical power to move the airframe.

In an elevator equipped with the equalizing system 500, an (elevator) car (cab, cage, carriage) is provided, for example, instead of the vehicle chassis 610 in FIG. 9. A hoist cable to raise and lower the car is provided instead of driving wheel(s) 603, an acceleration input section is provided instead of an accelerating device 604, and a deceleration input section is provided instead of a braking device 605. In this case, the (elevator) car is the main unit of the movable equipment, a motor is the mechanical power source, and the hoist cable is the driving section. In this equipment configuration, the motor receives electrical power from the equalizing system 500, electrical power is converted to mechanical power, and the hoist cable is driven by mechanical power to move the (elevator) car.

In a walking robot equipped with the equalizing system 500, a (robot) body is provided, for example, instead of the vehicle chassis 610 in FIG. 9. Legs are provided instead of driving wheel(s) 603, an acceleration input section is provided instead of an accelerating device 604, and a deceleration input section is provided instead of a braking device 605. In this case, the (robot) body is the main unit of the movable equipment, motor(s) are the mechanical power source, and the legs are the driving section. In this equipment configuration, the motor(s) receive electrical power from the equalizing system 500, electrical power is converted to mechanical power, and the legs are activated by mechanical power to move the (robot) body.

As described above, the movable equipment carries a equalizing system 500 on-board. The mechanical power source receives electric power from the equalizing system 500 and converts it to mechanical power, and the driving section moves the main unit of the movable equipment with mechanical power from the mechanical power source.

### (3-4) Effectiveness of the Electric-Powered Movable Equipment

By using the equalizing system 500 of the first or second embodiment in the various types of electric-powered movable equipment, terminal voltages of all the battery cells 10 can be efficiently equalized while constraining the size of the charging circuitry 62. Consequently, electric-powered movable equipment reliability can be improved while keeping the equipment from becoming oversized.

### (4) Fourth Embodiment

The following describes a power source apparatus for the fourth embodiment of the present invention.

### (4-1) Structure and Operation

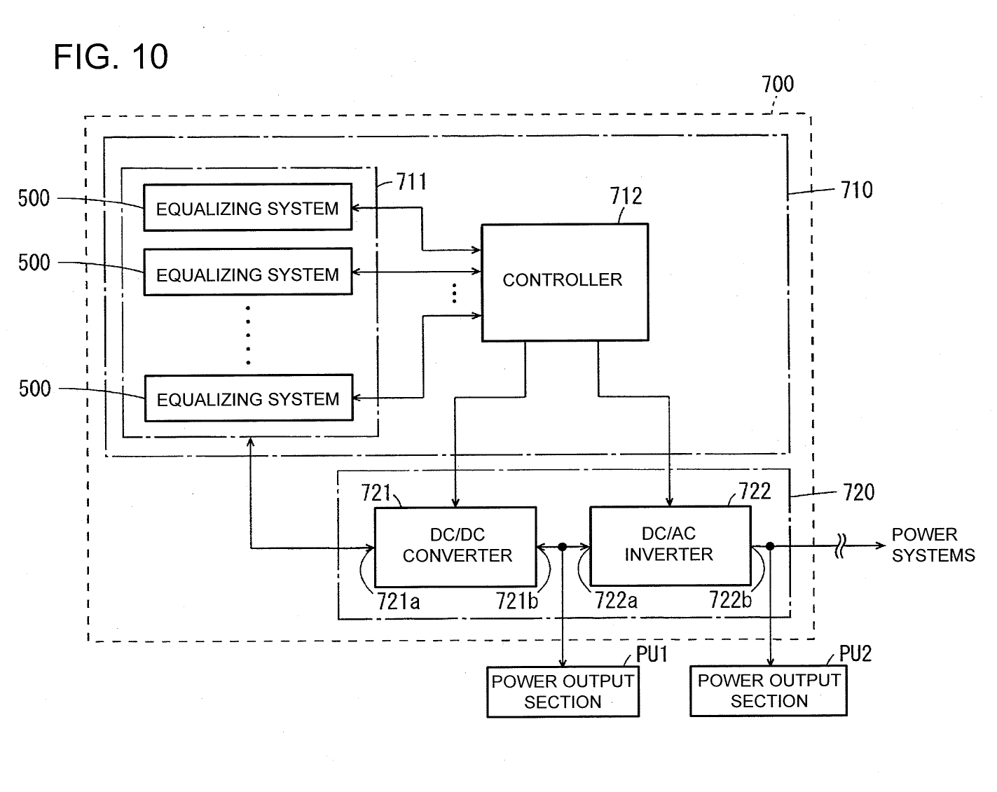

FIG. 10 is a block diagram showing the structure of a power source apparatus for the fourth embodiment. As shown in FIG. 10, the power source apparatus 700 is provided with a power storage device 710 and power conversion device 720. The power storage device 710 is provided with an array of equalizing system 711 and a controller 712. The array of equalizing systems 711 includes a plurality of equalizing systems 500 as described for the first or second embodiment. The (plurality of battery cells 10 of the) equalizing systems 500 can be connected in series or parallel. In each equalizing system 500, each battery cell group 110, and the plurality of discharging sections DU and voltage detection section 201 corresponding to that battery cell group 110 can be implemented (and packaged), for example, as a single unit.

The controller 712 is an example of a system control section and is a device such as a CPU and memory, or a microcomputer (or microcontroller). The controller 712 is connected to the battery ECUs 202 (refer to FIG. 1) included in each equalizing system 500. The battery ECU 202 in each equalizing system 500 computes the charge capacity of each battery cell 10 based on its terminal voltage and inputs the computed charge capacities to the controller 712. The controller 712 controls the power conversion device 720 based on the charge capacity of each battery cell 10 input from each battery ECU 202. This allows the controller 712 to perform control operations related to charging and discharging the plurality of battery cells 10 in each equalizing system 500.

The power conversion device 720 includes a direct current-to-direct current (DC/DC) converter 721 and a DC/AC inverter 722. The DC/DC converter 721 has input-output terminals 721a, 721b, and the DC/AC inverter 722 has input-output terminals 722a, 722b. The DC/DC converter 721 input-output terminal 721a is connected to the array of equalizing systems 711 in the power storage device 710. The input-output terminal 721b of the DC/DC converter 721 and the input-output terminal 722a of the DC/AC inverter 722 are connected together and to a power output section PU1. The input-output terminal 722b of the DC/AC inverter 722 is connected to power output section PU2 and to other power systems. The power output sections PU1, PU2 include, for example, power outlets (sockets). Various loads can be connected to the power output sections PU1, PU2. Other power systems include systems such as commercial power sources and solar cells. The power output sections PU1, PU2 and other power systems are examples of external connections to the power source apparatus.

The plurality of battery cells 10 included in the array of equalizing systems 711 are charged and discharged by controlling the DC/DC converter 721 and DC/AC inverter 722 via the controller 712.

When the array of equalizing systems 711 is discharged, power from the array of equalizing systems 711 is converted from DC power (at one voltage and current) to DC power (at another voltage and current) by the DC/DC converter 721 and is subsequently converted from DC power to AC power by the DC/AC inverter 722.

Power converted by the DC/DC converter 721 is supplied to power output section PU1. Power converted to AC by the DC/AC inverter 722 is supplied to power output section PU2. DC power is output to the outside from the power output section PU1 and AC power is output externally from the power output section PU2. Power converted to AC by the DC/AC inverter 722 can also be supplied to other power systems.

As one example of controlling discharge of the plurality of battery cells 10 included in each equalizing system 711, the controller 712 performs the following functions. During discharge of the array of equalizing systems 711, the controller 712 judges whether or not discharging should be suspended based on the charge capacity of each battery cell 10 input from each battery ECU 202 (refer to FIG. 1). The controller 712 controls the power conversion device 720 based that judgment. Specifically, when the charge capacity of any battery cell 10 of the plurality of battery cells 10 included in the array of equalizing systems 711 drops below a preset threshold value, the controller 712 controls the DC/DC converter 721 and the DC/AC inverter 722 to suspend discharging or to limit discharging current (or discharging power). This prevents over-discharging in each of the battery cells 10.

Meanwhile, when the array of equalizing systems 711 is charged, AC power from another power system is converted to DC by the DC/AC inverter 722 and further converted (power conditioned) by the DC/DC converter 721. The plurality of battery cells 10 (refer to FIG. 1) included in the array of equalizing systems 711 are charged by power input from the DC/DC converter 721

As one example of controlling charging of the plurality of battery cells 10 in each equalizing system 711, the controller 712 performs the following functions. During charging the array of equalizing systems 711, the controller 712 judges whether or not charging should be suspended based on the charge capacity of each battery cell 10 input from each battery ECU 202 (refer to FIG. 1). The controller 712 controls the power conversion device 720 based that judgment. Specifically, when the charge capacity of any battery cell 10 of the plurality of battery cells 10 included in the array of equalizing systems 711 rises above a preset threshold value, the controller 712 controls the DC/DC converter 721 and the DC/AC inverter 722 to suspend charging or to limit charging current (or charging power). This prevents over-charging in each of the battery cells 10.

### (4-2) Effectiveness

Since the power source apparatus 700 for this embodiment uses equalizing systems 500 of the first or second embodiment, the terminal voltages of all the battery cells 10 can be efficiently equalized while keeping the charging circuitry 62 from becoming oversized. Consequently, power source apparatus 700 reliability can be improved while constraining the size of the apparatus.

### (4-3) Other Power Source Apparatus Examples

Instead of providing battery ECUs 202 in each equalizing system 500 in the power source apparatus 700 of FIG. 10, the controller 712 can incorporate battery ECU 202 functionality. In that case, the first and second equalizing operations can be performed in each equalizing system 500 by controlling the equalizing apparatus 60 charging circuitry 62 and discharging circuitry 61 via the controller 712.

If it is possible to supply power mutually between the power source apparatus 700 and an external system, the power conversion device 720 may be provided with either a DC/DC converter 721 or a DC/AC inverter 722 (instead of both). Further, if it is possible to supply power mutually between the power source apparatus 700 and an external system, provision of the power conversion device 720 may be unnecessary.

Although the power source apparatus 700 in FIG. 10 is provided with a plurality of equalizing systems 500, it is not limited to that configuration and a single equalizing system 500 can also be provided.

### (5) Relation Between Structural Elements in the Claims and Components of the Embodiments

Although the following describes examples of associations between components of the embodiments and structural elements in the claims, the present invention is not limited to the examples below.

In the previously described embodiments, the equalizing apparatus 60 is an example of an equalizing apparatus, the battery cell 10 is an example of a battery cell, the battery cell group B1, B2, or B3 is an example of a battery cell group, the discharging section DU is an example of a discharging section, the charging circuitry 62 is an example of charging circuitry, the secondary coil L2 (L21, L22, or L23) is an example of a charging section and a second coil, the primary coil L1 is an example of a first coil, a switching device C3 (C31, C32, or C33) is an example of a first switch, the resistor R is an example of a resistor, and the switching device C1 is an example of a second switch.

The battery system 100 is an example of a battery system, the equalizing system 500 is an example of an equalizing system, the control section 200 is an example of a control section, the electric automobile 600 is an example of an electric-powered vehicle or electric-powered movable equipment, the motor 602 is an example of a motor or mechanical power source, the driving wheel(s) 603 are examples of driving wheel(s) or a driving section, the vehicle chassis 610 is an example of a main unit of the movable equipment, the power storage device 710 is an example of a power storage device, the power source apparatus 700 is an example of a power source apparatus, the controller 712 is an example of a system control section, and the power conversion device 720 is an example of a power conversion device.

Note that it is also possible to use various other elements having the structure or functions cited in the claims to implement each of the structural elements in the claims.

1-11. (canceled)

12. A battery system comprising:
a plurality of battery cell groups with each group including a plurality of series-connected battery cells; and
an equalizing apparatus to equalize the state of charge of the plurality of battery cell groups,
wherein the equalizing apparatus includes:
a plurality of discharging sections established in one-to-one correspondence with each of the plurality of battery cells in the plurality of battery cell groups; and
charging circuitry having a plurality of charging sections established in one-to-one correspondence with each of the plurality of battery cell groups;
wherein each discharging section is connected across the terminals of the corresponding battery cell, and
wherein each charging section is connected between the highest potential battery cell terminal and the lowest potential battery cell terminal of the corresponding battery cell group.

13. The battery system as cited in claim 12, wherein the charging circuitry includes:
a first coil connected to a power supply;
a plurality of second coils established as charging sections in one-to-one correspondence with the plurality of battery cell groups that can induce current flow due to magnetic field variation in the first coil; and
a plurality of first switches that operate independently for each of the plurality of second coils to switch between induced current flow and no induced current flow in each second coil.

14. The battery system as cited in claim 12, wherein the charging circuitry is configured to allow periodic switching between current flow and no current flow from the power supply to the first coil.

15. The battery system as cited in claim 12, wherein the discharging sections include:
a plurality of resistors established in one-to-one correspondence with each of the plurality of battery cells in the plurality of battery cell groups; and
a plurality of second switches that can independently switch between electrical connection and disconnection of each resistor to its corresponding battery cell terminals.

16. An equalizing apparatus that equalizes the state of charge of the plurality of battery cell groups, which each include a plurality of battery cells, comprising:
a plurality of discharging sections established in one-to-one correspondence with each of the plurality of battery cells in the plurality of battery cell groups; and
charging circuitry having a plurality of charging sections established in one-to-one correspondence with each of the plurality of battery cell groups,
wherein each discharging section is connected across the terminals of the corresponding battery cell, and
wherein each charging section is connected between the highest potential battery cell terminal and the lowest potential battery cell terminal of the corresponding battery cell group.

17. An equalizing system comprising:
the battery system as cited in claim 12; and
a control section that controls the plurality of discharging sections and the charging circuitry in the battery system.

18. The equalizing system as cited in claim 17, wherein the control section controls the plurality of discharging sections and the charging circuitry to first equalize the state of charge in each battery cell group and subsequently equalize the state of charge between the plurality of battery cell groups.

19. An electric-powered vehicle comprising:
the equalizing system as cited in claim 17;
a motor driven by power from the equalizing system; and
driving wheel(s) rotated by torque from the motor.

20. Electric-powered movable equipment comprising:
the equalizing system as cited in claim 17;
a main unit of the movable equipment;
a mechanical power source that receives electrical power from the equalizing system and converts that electrical power to mechanical power; and
a driving section that moves the main unit of the movable equipment with mechanical power converted from electrical power by the mechanical power source.

21. A power storage device comprising:
the equalizing system as cited in claim 17; and
a system control section that performs control related to charging and discharging the plurality of battery cells in the equalizing apparatus.

22. A power source apparatus that can connect with external systems comprising:
the power storage device as cited in claim 21; and
a power conversion device that is controlled by the power storage device system control section to perform power conversion between the plurality of battery cells in the power storage device and the outside.
